(19) United States
(12) Patent Application Publication
(10) Pub. No.: US 2023/0420852 A1
(43) Pub. Date: Dec. 28, 2023

(54) ANTENNA STRUCTURE AND IMAGE DISPLAY DEVICE INCLUDING THE SAME

(71) Applicant: DONGWOO FINE-CHEM CO., LTD., Jeollabuk-do (KR)

(72) Inventors: Won Hee LEE, Gyeonggi-do (KR); Young Ju KIM, Gyeonggi-do (KR)

(21) Appl. No.: 18/210,135

(22) Filed: Jun. 15, 2023

(30) Foreign Application Priority Data
Jun. 27, 2022 (KR) 10-2022-0077986

(51) Int. Cl. H01Q 9/04; H01Q 1/24; G01S 13/58; H01Q 21/24

(52) U.S. Cl. CPC H01Q 9/0428; H01Q 21/24; G01S 13/58; H01Q 1/243

(57) ABSTRACT

An antenna structure includes a first radiator, a second radiator, a third radiator and a fourth radiator. The first radiator and the second radiator are arranged along a first direction, and the second radiator and the third radiator are arranged along a second direction perpendicular to the first direction. The first radiator, the second radiator and the third radiator are circularly polarized radiators in the same rotational direction, and the fourth radiator is a circularly polarized radiator in a rotational direction opposite to that of the first radiator, the second radiator and the third radiator.

### PRIORITY

This application claims the benefit under 35 USC § 119 of Korean Patent Application No. 10-2022-0077986 filed on Jun. 27, 2022 in the Korean Intellectual Property Office (KIPO), the entire disclosures of which is incorporated herein by reference for all purposes.

### BACKGROUND

### 1. Field

The present invention relates to an antenna structure and an image display device including the same. More particularly, the present invention relates to an antenna structure including a plurality of radiators and an image display device including the same.

### 2. Description of the Related Art

As information technologies have been developed, a wireless communication technology such as Wi-Fi, Bluetooth, etc., or a non-contact sensing such as a gesture detection and a motion recognition is being applied to or embedded in image display devices, electronic devices and architecture. For example, an antenna for performing communication in a high frequency or ultra-high frequency band is applied to various mobile devices.

For example, the wireless communication technology is combined with a display device in, e.g., a smartphone form. In this case, the antenna may be combined with the display device to provide a communication function.

As the display device to which the antenna is employed becomes thinner and lighter, a space for the antenna may also decrease. Accordingly, the antenna may be included in the form of a film or patch on a display panel so as to insert the antenna in a limited space.

However, when the antenna is disposed on the display panel, a coaxial circuit for transmitting and receiving signals or performing a feeding may not be easily constructed. Further, sensitivity may be lowered, or spatial efficiency and aesthetic property of a structure to which an antenna device is applied may be hindered due to an insertion of a coaxial power supply circuit.

For example, Korean Patent Publication No. 10-2014-0104968 discloses an antenna device including an antenna element and a ground element.

### SUMMARY

According to an aspect of the present invention, there is provided an antenna structure having improved signaling efficiency and radiation reliability.

According to an aspect of the present invention, there is provided an image display device including the antenna structure.

(1) An antenna structure including a first radiator, a second radiator, a third radiator and a fourth radiator, wherein the first radiator and the second radiator are arranged along a first direction, and the second radiator and the third radiator are arranged along a second direction perpendicular to the first direction, and the first radiator, the second radiator and the third radiator are circularly polarized radiators in the same rotational direction, and the fourth radiator is a circularly polarized radiator in a rotational direction opposite to that of the first radiator, the second radiator and the third radiator.

(2) The antenna structure according to the above (1), further including: a first transmission line connected to the first radiator at the same layer as that of the first radiator; a second transmission line connected to the second radiator at the same layer as that of the second radiator; a third transmission line connected to the third radiator at the same layer as that of the third radiator; and a fourth transmission line connected to the fourth radiator at the same layer as that of the fourth radiator.

(3) The antenna structure according to the above (2), wherein each of the first radiator, the second radiator, the third radiator and the fourth radiator has an asymmetrical shape with respect to each feeding axis.

(4) The antenna structure according to the above (3), wherein the first transmission line extends in a straight line along a feeding axis of the first radiator, the second transmission line extends in a straight line along a feeding axis of the second radiator, and the third transmission line extends in a straight line along a feeding axis of the third radiator.

(5) The antenna structure according to the above (4), wherein an extension direction of the first transmission line and an extension direction of the second transmission line are parallel to each other, and the extension direction of the second transmission line and an extension direction of the third transmission line are perpendicular to each other.

(6) The antenna structure according to the above (3), wherein the second radiator and the third radiator have the same shape as that of the first radiator based on each feeding direction, and

the fourth radiator has a reversed shape of the first radiator.

(7) The antenna structure according to the above (3), wherein each of the first radiator, the second radiator, the third radiator and the fourth radiator independently has a polygonal shape in which at least one vertex portion is truncated.

(8) The antenna structure according to the above (7), wherein each of the first radiator, the second radiator, the third radiator and the fourth radiator independently has a shape in which two vertex portions facing each other among four vertex portions in a quadrangle are truncated.

(9) The antenna structure according to the above (8), wherein the first radiator, the second radiator and the third radiator have a shape in which two vertex portions corresponding to the same positions based on each feeding direction are truncated, and the two truncated vertex portions of the fourth radiator and the two truncated vertex portions of the first radiator correspond to different positions based on each feeding direction.

(10) The antenna structure according to the above (2), wherein the first radiator, the second radiator, the third radiator and the fourth radiator are disposed at the same layer.

(11) The antenna structure according to the above (1), further including a dielectric layer on which the first radiator, the second radiator, the third radiator and the fourth radiator are disposed, wherein the first direction is parallel to a width direction of the dielectric layer, and the second direction is perpendicular to the width direction of the dielectric layer.

(12) The antenna structure according to the above (1), further including a dielectric layer on which the first radiator, the second radiator, the third radiator and the fourth radiator are disposed, wherein the first direction is inclined by a first tilt angle with respect to a width direction of the dielectric layer, and the second direction is inclined by a second tilt angle with respect to the width direction of the dielectric layer.

(13) The antenna structure according to the above (12), wherein the first tilt angle and the second tilt angle are each in a range from 30° to 60°.

(14) The antenna structure according to the above (1), wherein the first radiator, the second radiator and the third radiator serve as reception radiators, and the fourth radiator serves as a transmission radiator.

(15) A motion recognition sensor including the antenna structure according to the above-described embodiments.

(16) A radar sensor including the antenna structure according to the above-described embodiments.

(17) An image display device, including: a display panel; and the antenna structure according to the above-described embodiments disposed on the display panel.

(18) The image display device according to the above (17), wherein the first direction is parallel to a width direction of the display panel, and the second direction is perpendicular to the width direction of the display panel, and the second radiator is the closest to a corner portion of the display panel among the first radiator, the second radiator and the third radiator.

(19) The image display device according to the above (17), further including: a motion sensor driving circuit coupled to the antenna structure; and a flexible printed circuit board electrically connecting the antenna structure and the motion sensor driving circuit.

According to embodiments of the present invention, an antenna structure may include a first radiator, a second radiator and a third radiator which may be driven independently from each other. A first direction in which the first radiator and the second radiator are arranged and a second direction in which the third radiator and the second radiator are arranged may be perpendicular to each other. Accordingly, a strength and a change of a signal in two directions perpendicular to each other may be detected by the antenna structure.

The antenna structure may include transmission lines connected to each of the radiators, and each of the radiators may have an asymmetrical shape with respect to a feeding axis extending in a feeding direction. Accordingly, even though feedings of the first radiator, the second radiator and the third radiator are performed in different directions, circular polarization properties in the same polarization direction may be provided. A degree of freedom of a transmission line design within the antenna structure may also be enhanced.

The transmission line may extend in a straight line along the feeding direction of the radiator. Accordingly, signal and power loss due to the transmission line may be reduced, and gain and signal sensitivity of the antenna structure may be improved. Thus, sensing performance for distance, motion or movement of a sensing target may be improved.

The antenna structure may be electrically coupled to a motion sensor driving circuit or a radar processor through a circuit board. Accordingly, signal information obtained from the sensing target may be transmitted to the motion sensor driving circuit or the radar processor, and a change of position and distance of the sensing target may be measured based on the collected information.

### BRIEF DESCRIPTION OF THE DRAWINGS

FIGS. 1 and 2 are schematic plan views illustrating antenna structures in accordance with exemplary embodiments.

FIG. 3 is a schematic plan view illustrating an antenna structure in accordance with exemplary embodiments.

FIG. 4 is a schematic plan view illustrating an antenna structure in accordance with exemplary embodiments.

FIG. 5 is a schematic plan view illustrating an antenna structure in accordance with exemplary embodiments.

FIG. 6 is a schematic plan view illustrating an antenna structure in accordance with exemplary embodiments.

FIGS. 7 and 8 are a schematic plan view and a cross-sectional view illustrating an image display device in accordance with exemplary embodiments.

### DETAILED DESCRIPTION OF THE EMBODIMENTS

According to exemplary embodiments of the present invention, an antenna structure including a plurality of radiators arranged in two perpendicular directions.

According to exemplary embodiments of the present invention, an image display device including the antenna structure is also provided. However, an application of the antenna structure is not limited to the display device, and the antenna structure may be applied to various objects or structures such as a vehicle, a home electronic appliance, an architecture, etc.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “third”, “fourth”, “one end”, “other end”, “upper side”, “lower side”, “upper side”, “lower side”, etc., as used herein are not intended to limit an absolute position or order, but is used in a relative sense to distinguish different components or elements.

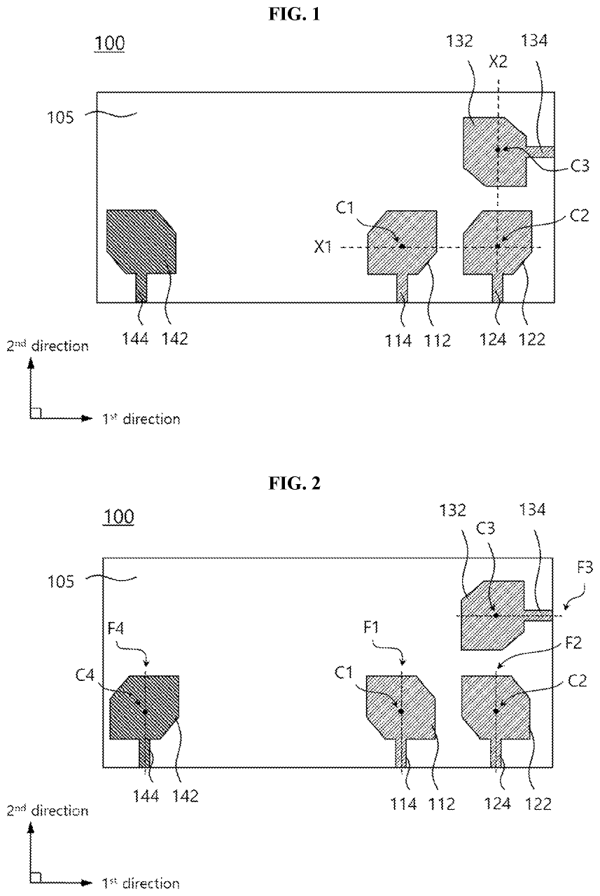

FIGS. 1 and 2 are schematic plan views illustrating antenna structures in accordance with exemplary embodiments.

Referring to FIG. 1, the antenna structure 100 may include a dielectric layer 105, and a first radiator 112, a second radiator 122 and a third radiator 132 disposed on the dielectric layer 105.

The dielectric layer 105 may include, e.g., a transparent resin material. For example, the dielectric layer 105 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more thereof.

The dielectric layer 105 may include an adhesive material such as an optically clear adhesive (OCA), an optically clear resin (OCR), or the like. In some embodiments, the dielectric layer 105 may include an inorganic insulating material such as glass, silicon oxide, silicon nitride, silicon oxynitride, etc.

In an embodiment, the dielectric layer 105 may be provided as a substantially single layer.

In an embodiment, the dielectric layer 105 may include a multi-layered structure of at least two layers. For example, the dielectric layer 105 may include a substrate layer and an antenna dielectric layer, and may include an adhesive layer between the substrate layer and the antenna dielectric layer.

Capacitance or inductance for the antenna structure 100 may be formed by the dielectric layer 105, so that a frequency band at which the antenna structure may be driven or operated may be adjusted. In some embodiments, a dielectric constant of the dielectric layer 105 may be adjusted in a range from about 1.5 to about 12. If the dielectric constant exceeds about 12, a driving frequency may be excessively decreased, and driving in a desired high frequency or ultrahigh frequency band may not be implemented.

In some embodiments, a ground layer may be disposed on a bottom surface of the dielectric layer 105. Generation of an electric field in a transmission line may be more promoted by the ground layer, and an electrical noise around the transmission line may be absorbed or shielded.

In some embodiments, the ground layer may be included an individual member of the antenna structure 100. In some embodiments, a conductive member of an image display device to which the antenna structure 100 is applied may serve as the ground layer.

For example, the conductive member may include various electrodes or wirings such as, e.g., a gate electrode, a source/drain electrode, a pixel electrode, a common electrode, a scan line, a data line, etc., included in a thin film transistor (TFT) array of a display panel.

In an embodiment, a metallic member disposed at a rear portion of the display device such as a SUS plate, a sensor member such as a digitizer, a heat dissipation sheet, etc., may serve as the ground layer.

In example embodiments, the first radiator 112 and the second radiator 122 may be arranged in a first direction. For example, the first radiator 112 and the second radiator 122 may be spaced apart from each other along a first axis X1 extending in the first direction. The first axis X1 may be an imaginary straight line passing through a central point C1 of the first radiator 112 and a central point C2 of the second radiator 122 and extending in the first direction.

In example embodiments, the second radiator 122 and the third radiator 132 may be arranged in a second direction. For example, the second radiator 122 and the third radiator 132 may be spaced apart from each other along a second axis X2 extending in the second direction. The second axis X2 may be an imaginary straight line passing through the central point C2 of the second radiator 122 and a central point C3 of the third radiator 132 and extending in the second direction.

For example, the first radiator 112, the second radiator 122 and the third radiator 132 may be spaced apart from each other, and may be driven independently. Thus, signal changes in the first direction and the second direction according to positional change of a sensing target may be measured. A motion and a moving distance of the sensing target may be detected through the measured signal changes.

In example embodiments, the first direction and the second direction may be perpendicular to each other. Thus, the antenna structure 100 may detect signal intensities with respect to the sensing target in two axes X1 and X2 orthogonal to each other. For example, the antenna structure may transfer changes of the signal intensities in the two orthogonal axes to a motion sensor driving circuit or a radar processor. Positional changes, gestures or distances of the sensing target in all directions on an X-Y coordinate system may be measured by the motion sensor driving circuit or the radar processor based on the collected information.

The antenna structure 100 may be used for a motion sensor for detecting motions and gestures or a radar for detecting the distance. The first radiator 112, the second radiator 122 and the third radiator 132 may serve as reception radiators for detecting the motion or the distance. For example, the first radiator 112, the second radiator 122 and the third radiator 132 may receive signals reflected from the sensing target.

The second radiator 122 may serve as a reference point for measuring signal changes in the first axis X1 and the second axis X2. For example, the motion of the sensing target may be sensed by measuring the changes of the signal intensities in the first axis X1 and the second axis X2 based on the signal intensity of the second radiator 122.

In some embodiments, each of the radiators 112, 122 and 132 may be designed to have a resonance frequency in a high frequency or ultra-high frequency band of, e.g., 3G, 4G, 5G or higher. For example, the resonance frequency of each of the radiators 112, 122 and 132 may be about 50 GHz or higher, and may be, e.g., in a range from 50 GHz to 80 GHz, or from 55 GHz to 77 GHz.

In some embodiments, a spacing distance in the first direction between the first radiator 112 and the second radiator 122, and a spacing distance in the second direction between the second radiator 122 and the third radiator 132 may be substantially the same. In this case, the signal intensities in the first direction and the second direction may be measured at regular distance intervals. Accordingly, the signal changes in the first direction and the second direction according to the position and distance of the sensing target may be more accurately measured.

In some embodiments, the antenna structure 100 further include a first transmission line 114, a second transmission line 124 and a third transmission line 134 connected to the first radiator 112, the second radiator 122 and the third radiator 132, respectively. Thus, the first radiator 112, the second radiator 122 and the third radiator 132 may be driven independently from each other, and electromagnetic wave signals in the first axis X1 and the second axis X2 may each be measured independently.

The first transmission line 114 may be electrically connected to the first radiator 112 at the same layer as that of the first radiator 112. For example, the first transmission line 114 may be integrally connected to the first radiator 112 and may extend from one end of the first radiator 112.

The second transmission line 124 may be electrically connected to the second radiator 122 at the same layer as that of the second radiator 122. For example, the second transmission line 124 may be integrally connected to the second radiator 122 and may extend from one end of the second radiator 122.

The third transmission line 134 may be electrically connected to the third radiator 132 at the same layer as that of the third radiator 132. For example, the third transmission line 134 may be integrally connected to the third radiator 132 and may extend from one end of the third radiator 132.

For example, the first transmission line 114, the second transmission line 124 and the third transmission line 134 may each transmit a driving signal or a power of an antenna driving integrated circuit (IC) chip to the first radiator 112, the second radiator 122 and the third radiator 132, respectively.

For example, the first transmission line 114, the second transmission line 124 and the third transmission line 134 may transmit the electromagnetic wave signal or electrical signal to the antenna driving IC chip, the motion sensor driving circuit or the radar processor.

In some embodiments, the first transmission line 114, the second transmission line 124 and the third transmission line 134 may be disposed at the same layer or at the same level as that of the first radiator 112, the second radiator 122 and the third radiator 132, respectively.

The transmission lines 114, 124 and 134 may be disposed at the same level as that of the radiators 112, 122 and 132, so that feeding/driving may be performed without a separate coaxial power supply for signal input/output and feeding. Thus, for example, an antenna on display (AoD) in which the antenna structure 100 is disposed on a display panel may be implemented.

In some embodiments, the first transmission line 114, the second transmission line 124 and the third transmission line 134 may be disposed at different layers or at different levels from that of the first radiator 112, the second radiator 122 and the third radiator 132, respectively, on the dielectric layer 105. In this case, the transmission lines 114, 124 and 134 and the radiators 112, 122 and 132 may be electrically connected to each other through a via.

In example embodiments, the antenna structure 100 may further include a fourth radiator 142 disposed to be spaced apart from the first radiator 112, the second radiator 122 and the third radiator 142.

The antenna structure 100 may further include a fourth transmission line 144 connected to the fourth radiator 142 at the same layer as that of the fourth radiator 142.

The fourth radiator 142 may be provided as a transmission radiator of the antenna structure 100. For example, the fourth radiator 142 may radiate an electromagnetic wave toward the sensing target. The first radiator 112, the second radiator 122 and the third radiator 132 may receive the electromagnetic wave signal reflected from the sensing target.

The first radiator 112, the second radiator 122, the third radiator 132 and the fourth radiator 142 may each independently have a circular polarization property.

When feeding directions and polarization directions of radiators having a linear polarization property do not coincide with each other, signal transmission and reception efficiency may be deteriorated, and antenna gain and coverage may also be decreased. To match the feeding directions and the polarization directions of the radiators arranged perpendicularly to each other, the transmission line may be designed to have a curved structure or a length of the transmission line may be increased. In this case, signal and power loss due to the transmission line may be increased, and signal efficiency may be degraded.

However, according to exemplary embodiments, the radiators 112, 122, 132, and 142 may have the circular polarization property, so that the polarization directions of the reception radiators may be substantially the same even when the feeding directions are different. Accordingly, the signal efficiency of the antenna structure 100 may be increased. Further, a degree of freedom of feeding design may be increased, and the length of the transmission line may be reduced, thereby suppressing the signal and feeding losses.

The first radiator 112 the second radiator 122 and the third radiator 132 may have the same polarization direction. For example, the first radiator 112, the second radiator 122 and the third radiator 132 may have the circular polarization property in the same rotational direction. The polarization directions of the reception radiators may be constructed to coincide with each other, so that a reception efficiency of the antenna structure 100 may be increased while improving sensing performance.

The fourth radiator 142 may have a polarization direction opposite to that of the first radiator 112, the second radiator 122 and the third radiator 132. For example, the fourth radiator 142 may have a circular polarization property in a direction opposite to that of the first radiator 112, the second radiator 122 and the third radiator 132.

For example, the reception radiators may be circularly polarized radiators in the same rotational direction, and the transmission radiator may be circularly polarized radiator in an opposite rotational direction to that of the reception radiators.

In one embodiment, when the first radiator 112, the second radiator 122 and the third radiator 132 have a right hand circular polarization (RHCP) property, the fourth radiator 142 may have a left hand circular polarization (LHCP) property.

In one embodiment, when the first radiator 112, the second radiator 122 and the third radiator 132 have a left hand circular polarization (LHCP) property, the fourth radiator 142 may have a right hand circular polarization (RHCP) property.

When the signal transmitted from the transmission radiator is reflected on the sensing target, the polarization direction may be reversed. Accordingly, the polarization direction of the reception radiator may be designed to be opposite to that of the transmission radiator, so that the signal reflected from the sensing target may be efficiently received. Thus, signal transmission/reception performance of the antenna structure 100 may be improved, and measurement sensitivity and accuracy of the motion, gesture and distance of the sensing target may be improved.

As illustrated in FIG. 2, the first radiator 112, the second radiator 122, the third radiator 132 and the fourth radiator 142 may each have an asymmetrical shape with respect to each of a feeding axis F1, F2, F3 and F4. For example, the feeding axis F1, F2, F3 and F4 may refer to an imaginary straight line extending along the feeding direction of the radiators 112, 122, 132, and 142. The feeding axis F1, F2, F3 and F4 may pass through a point where the radiator is connected to the transmission line and a central point C1, C2, C3 and C4 of the radiator.

As the radiators 112, 122, 132, and 142 have the asymmetrical shape with respect to each of the feeding axis F1, F2, F3 and F4, a linear polarized signal input through the transmission lines 114, 124, 134 and 144 may be converted into a circularly polarized signal. Accordingly, each of the radiators 112, 122, 132 and 142 may transmit and receive the circularly polarized signal.

In some embodiments, the first radiator 112, the second radiator 122 and the third radiator 132 may have the same shape with reference to each feeding direction. The fourth radiator 142 may have a shape in which the first radiator 112, the second radiator 122 or the third radiator 132 are inverted with respect to the feeding direction. Thus, the first radiator 112, the second radiator 122 and the third radiator 132 may have the circular polarization property in the same direction, and the fourth radiator 142 may have the circular polarization property in the opposite direction.

In example embodiments, the first radiator 112, the second radiator 122, the third radiator 132 and the fourth radiator 142 may each independently have a polygonal shape in which at least one vertex portion is truncated. For example, at least one vertex portion may be cut into a triangular shape or may have a rounded shape. Accordingly, each of the radiators 112, 122, 132 and 142 may have an asymmetrical shape with respect to each feeding axis.

For example, in each of the first radiator 112, the second radiator 122, the third radiator 132, and the fourth radiator 142, two diagonally opposite vertex portions among four vertex portions of a quadrangle may have a cut shape.

In one embodiment, truncated vertex portions of the first radiator 112, the second radiator 122 and the third radiator 132 may correspond to the identical positions with respect to the feeding directions or feeding axis F1, F2 and F3. The truncated vertex portions of the fourth radiator 142 may correspond to different positions from those of the truncated vertex portions in the first radiator 112, the second radiator 122 and the third radiator 132 based on the feeding direction or the feeding axis F4.

Referring again to FIG. 1, the first radiator 112, the second radiator 122 and the third radiator 132 may have truncated or rounded vertex portions at an upper left vertex portion and a lower right vertex portion with respect to each feeding direction or feeding axis. In this case, the first radiator 112, the second radiator 122 and the third radiator 132 may have the left hand circular polarization property.

The fourth radiator 142 may have a structure in which an upper right vertex portion and a lower left vertex portion are truncated or rounded with respect to the feeding direction or the feeding axis. In this case, the fourth radiator 142 may have the right hand circular polarization property.

Referring to FIG. 2, the first radiator 112, the second radiator 122 and the third radiator 132 may have a structure where an upper right vertex portion and a lower left vertex portion are truncated or rounded with respect to each feeding direction or feed axis F1, F2 and F3. In this case, the first radiator 112, the second radiator 122 and the third radiator 132 may have the right hand circular polarization property.

The fourth radiator 142 may have a structure in which an upper left vertex portion and a lower right vertex portion are truncated or rounded with respect to the feeding direction or the feeding axis F4. In this case, the fourth radiator 142 may have the left hand circular polarization property.

In example embodiments, each of the first transmission line 114, the second transmission line 124, the third transmission line 134 and the fourth transmission line 144 may extend along the feeding axis F1, F2, F3 and F4 of the radiator 112, 122, 132 and 142, respectively.

For example, the first transmission line 114 may extend in a straight line along the feeding F1 of the first radiator 112. For example, the second transmission line 124 may extend in a straight line along the feeding axis F2 of the second radiator 122. For example, the third transmission line 134 may extend in a straight line along the feeding axis F3 of the third radiator 132. For example, the fourth transmission line 144 may extend in a straight line along the feeding axis F4 of the fourth radiator 142.

The transmission lines 114, 124, 134 and 144 may each extend in a straight line, so that resistance may be lowered, and signal and feeding efficiency may be improved. Additionally, radiation loss due to a bent or folded structure of the transmission lines 114, 124, 134 and 144 may be prevented to increase gain of the antenna structure 100.

In example embodiments, an extension direction of the first transmission line 114 and an extension direction of the second transmission line 124 may be parallel to each other. The extension direction of the second transmission line 124 and an extension direction of the third transmission line 134 may be perpendicular to each other.

For example, the extension direction of the first transmission line 114 and the extension direction of the second transmission line 124 may be parallel to the second direction. The extending direction of the third transmission line 134 may be parallel to the first direction.

Accordingly, the second radiator 122 may be disposed to be adjacent to the vertex portion of the dielectric layer 105 and the vertex portion of the image display device without being hindered by the transmission line. For example, the antenna structure 100 may be disposed to be adjacent to the vertex portion or an edge area of the image display device.

Thus, a feeding distance between the radiator 112, 122 and 132 and an external circuit structure and the length of the transmission line 114, 124 and 134 may become smaller. Accordingly, signal loss and resistance increase may be prevented.

In one embodiment, the first transmission line 114, the second transmission line 124 and the third transmission line 134 may have substantially the same length. Accordingly, signal intensities in the first axis X1 and the second axis X2 may be measured uniformly and accurately.

In some embodiments, the first transmission line 114 and the second transmission line 124 may be electrically connected to one circuit board, and the third transmission line 134 may be electrically connected to another circuit board.

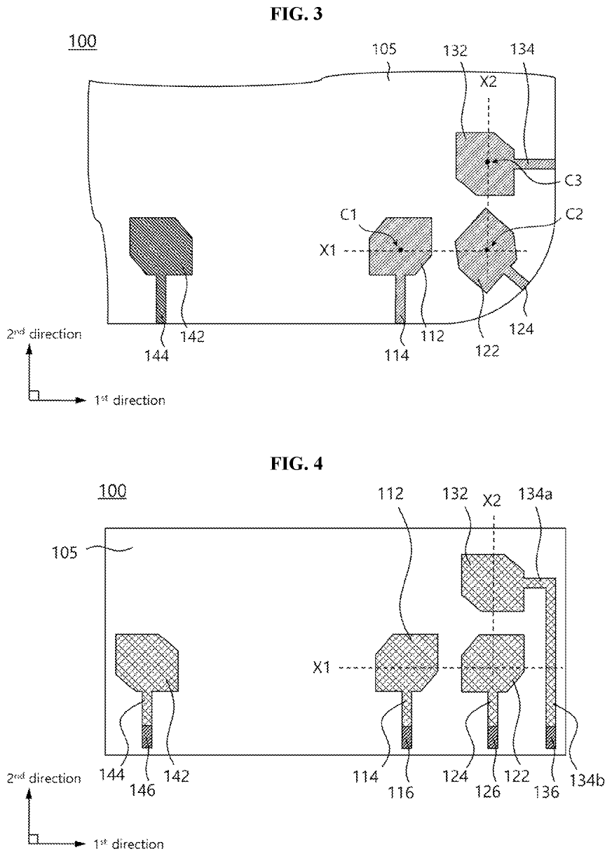

FIG. 3 is a schematic plan view illustrating an antenna structure in accordance with exemplary embodiments.

Referring to FIG. 3, the dielectric layer 105 may include at least one rounded corner portion. Thus, the antenna structure 100 can be easily disposed at the edge area or the corner portion of the image display device.

In example embodiments, the first transmission line 114, the second transmission line 124 and the third transmission line 134 may all extend in different directions. The radiators 112, 122 and 132 may have the circular polarization property, so that signals of the same polarization direction may be received even when the feeding directions are not parallel to each other.

In one embodiment, the first transmission line 114 may extend in the second direction, and the third transmission line 134 may extend in the first direction. The second transmission line 124 may extend in a direction inclined at a predetermined angle with respect to the first direction or the second direction.

For example, the second transmission line 124 may extend toward the corner portion of the dielectric layer 105 or the image display device. Accordingly, the second radiator 122 may be adjacent to the corner portion of the dielectric layer 105 or the image display device, and thus the length of the second transmission line 124 may be decreased. Thus, a distance between the second radiator 122 and the circuit board may also be decreased, so that increase of a line resistance and signal loss may be suppressed.

Additionally, the radiators 112, 122 and 132 may be adjacent to the rounded corner portion. Thus, the antenna structure 100 may be positioned at the edge or corner portion of the image display device, and interference with other circuit structures may be prevented.

FIG. 4 is a schematic plan view illustrating an antenna structure in accordance with exemplary embodiments.

Referring to FIG. 4, the third transmission line 134 may have a bent portion or a folded portion. For example, the third transmission line 134 may include a first feeding portion 134a that is connected to the third radiator 132 and extends along the feeding axis F3 of the third radiator 132, and a second feeding portion 134b that is connected to the first feeding portion 134a and extends in a direction perpendicular to the feeding axis F3 of the third radiator 132.

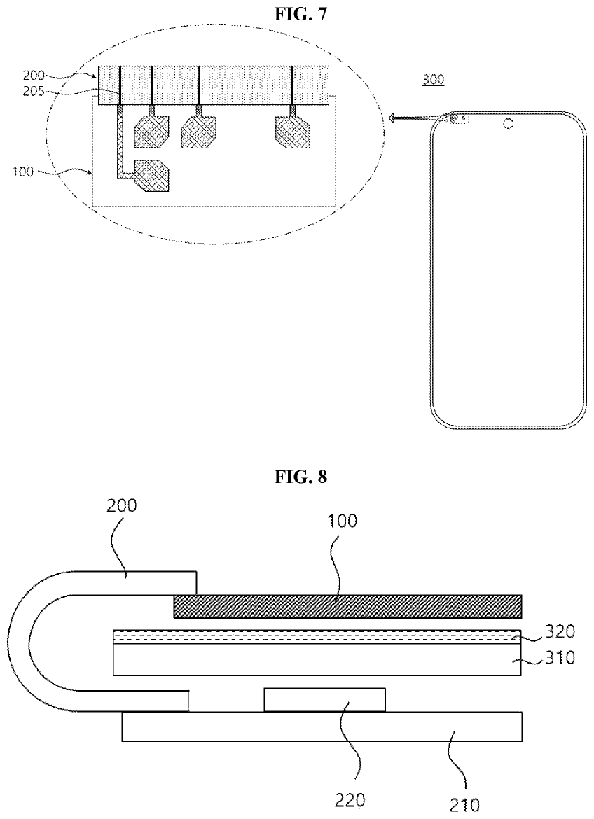

Thus, end portions of the first transmission line 114, the second transmission line 124 and the third transmission line 134 may be arranged along the same direction (e.g., the first direction). Accordingly, the first transmission line 114, the second transmission line 124 and the third transmission line 134 may be electrically connected to a single circuit board (e.g., see FIG. 7).

In example embodiments, the radiators 112, 122, 132 and 142 and/or the transmission lines 114, 124, 134 and 144 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the metals. These may be used alone or in a combination of at least two therefrom.

In one embodiment, the radiators 112, 122, 132 and/or 142 and the transmission lines 114, 124, 134 and 144 may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the radiators 112, 122, 132 and 142 and/or the transmission lines 114, 124, 134 and 144 may include a transparent conductive oxide such as indium tin oxide (ITO), indium zinc oxide (IZO), indium zinc tin oxide (ITZO), zinc oxide (ZnOx), etc.

In some embodiments, the radiators 112, 122, 132 and 142 and/or the transmission lines 114, 124, 134 and 144 may include a stacked structure of a transparent conductive oxide layer and a metal layer, and may include, e.g., a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The radiators 112, 122, 132 and 142 and/or the transmission lines 114, 124, 134 and 144 may include a blackened portion, so that a reflectance at a surface of the radiators 112, 122, 132 and 142 and/or the transmission lines 114, 124, 134 and 144 may be decreased to suppress a visual pattern recognition due to a light reflectance.

In an embodiment, a surface of the metal layer included in the radiators 112, 122, 132 and 142 and/or the transmission lines 114, 124, 134 and 144 may be converted into a metal oxide or a metal sulfide to form a blackened layer. In an embodiment, a blackened layer such as a black material coating layer or a plating layer may be formed on the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

In some embodiments, the antenna structure 100 may further include signal pads 116, 126, 136 and 146. A first signal pad 116 may be connected to one end portion of the first transmission line 114. The second signal pad 126 may be connected to one end portion of the second transmission line 124. The third signal pad 136 may be connected to one end portion of the third transmission line 134. The fourth signal pad 146 may be connected to one end portion of the fourth transmission line 144.

In one embodiment, the signal pads 116, 126, 136 and 146 may be provided as substantially integral members with the transmission lines 114, 124 134, and 144. For example, the one end portions of the transmission lines 114, 124, 134 and 144 may serve as signal pads 116, 126, 136 and 146.

In some embodiments, a ground pad may be disposed around the signal pad 116, 126, 136 and 146. For example, a pair of the ground pads may be disposed to face each other with the signal pad 116, 126, 136 and 146 interposed therebetween.

The ground pad may be electrically and physically separated from the transmission line 114, 124, 134 and 144 and the signal pad 116, 126, 136 and 146.

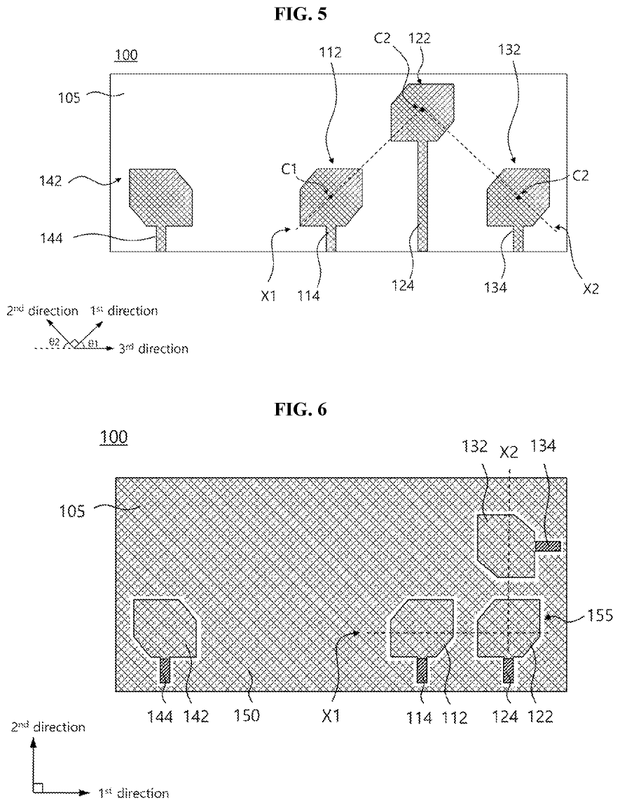

FIG. 5 is a schematic plan view illustrating an antenna structure in accordance with exemplary embodiments.

Referring to FIG. 5, the first axis X1 and the second axis X2 may be inclined by a predetermined tilt angle with respect to the width direction (e.g., a third direction) of the dielectric layer 105.

In some embodiments, the first direction may be inclined by a first tilt angle θ1 with respect to the width direction of the dielectric layer 105, and the second direction may be inclined by a second tilt angle θ2 with respect to the width direction of the dielectric layer 105. Accordingly, deviation of a length difference between the first transmission line 114 and the second transmission line 124 and a length difference between the second transmission line 124 and the third transmission line 134 may be reduced.

A feeding distance deviation between radiators arranged in the first direction and a feed distance deviation between radiators arranged in the second direction may be substantially the same. Accordingly, difference between a signal sensitivity in the first axis X1 and a signal sensitivity in the second axis X2 may be reduced, and a measurement error due to the difference of the signal sensitivity may be avoided or reduced.

In some embodiments, each of the first tilt angle θ1 and the second tilt angle θ2 may be in a range from 15° to 75°, preferably from 30° to 60°. Within the above range, the first radiator 112 and the third radiator 132 may be substantially symmetrically disposed on the same plane with respect to the second radiator 122. Accordingly, sensitivity to a signal change in the first axis X1 and a signal change in the second axis X2 according to the positional change of the sensing target may be increased.

In one embodiment, the first tilt angle θ1 and the second tilt angle θ2 may be substantially 45°. In this case, the lengths of the first transmission line 114 and the third transmission line 134 may be substantially the same. Accordingly, balance between the signal sensitivity in the first direction and the signal sensitivity in the second direction may be enhanced, and measurement accuracy may be increased.

FIG. 6 is a schematic plan view illustrating an antenna structure in accordance with exemplary embodiments.

Referring to FIG. 6, the first radiator 112, the second radiator 122, the third radiator 132 and the fourth radiator 142 may each have a mesh structure. Accordingly, transmittance of the antenna structure 100 may be improved.

In example embodiments, the radiators 112, 122, 132 and 142 and the transmission lines 114, 124, 134 and 144 may entirely include the mesh structure.

In one embodiment, at least a portion of the transmission lines 114, 124, 134 and 144 may include a solid structure to improve feeding efficiency. For example, terminal end portions of the transmission lines 114, 124, 134 and 144 may have a solid structure. In this case, the terminal end portions of the transmission lines 114, 124, 134 and 144 may serve as signal pads.

In some embodiments, the antenna structure 100 may further include a dummy mesh pattern 150 disposed around the first radiator 112, the second radiator 122, the third radiator 132 and the fourth radiator 142. For example, the dummy mesh pattern 150 may be electrically and physically separated from the radiators 112, 122, 132 and 142 and the transmission lines 114, 124, 134 and 144 by a separation region 155.

For example, a conductive layer containing the above-mentioned metal or alloy may be formed on the dielectric layer 105. A mesh structure may be formed while etching the conductive layer along profiles of the radiators 112, 122, 132 and 142 and transmission lines 114, 124, 134 and 144 as described above. Accordingly, the dummy mesh pattern 150 spaced apart from the radiators 112, 122, 132 and 142 and the transmission lines 114, 124, 134 and 144 by the separation region 155 may be formed

As the dummy mesh pattern 150 is distributed, optical properties around the radiators 112, 122, 132 and 142 may become uniform, and transmittance of the antenna structure 100 may be improved. Thus, the antenna structure 100 may be prevented from being visually recognized.

FIGS. 7 and 8 are a schematic plan view and a cross-sectional view illustrating an image display device in accordance with exemplary embodiments.

FIG. 7 illustrates a front portion or a window surface of the image display device 300. The front portion of the image display device 300 may include a display area and a non-display area. The non-display area may correspond to, e.g., a light-shielding portion or a bezel portion of the image display device 300.

The antenna structure 100 may be disposed toward the front portion of the image display device 300, and may be disposed on, e.g., a display panel. Accordingly, the antenna structure 100 may detect a motion, a distance or a gesture of a sensing target on the front portion of the image display device 300.

In some embodiments, the antenna structure 100 may be attached to the display panel in the form of a film.

In an embodiment, the antenna structure 100 may be formed throughout the display area and the non-display area of the image display device 300. In one embodiment, the radiators 112, 122, 132 and 142 may at least partially overlie the display area.

As described above, portions having the solid structure of the transmission lines 114, 124, 134 and 144, and the signal pads 116, 126, 136 and 146 may be disposed in the non-display area.

In some embodiments, the antenna structure 100 may be positioned at a corner portion of the image display device 300. For example, the second radiator 122 may be disposed to be adjacent to the corner portion of the image display device 300 or the corner portion of the display panel.

In one embodiment, the first direction of the antenna structure 100 may be parallel to a width direction of the image display device 300, and the second direction may be perpendicular to the width direction of the image display device 300. In one embodiment, the first direction of the antenna structure 100 may be parallel to a length direction of the image display device 300, and the second direction may be perpendicular to the length direction of the image display device 300.

Thus, a feeding distance between the radiators 112, 122, 132 and 142 and a circuit board 200 may be decreased. Accordingly, the lengths of the transmission lines 114, 124, 134 and 144 may be decreased, and a motion sensing performance may be further improved by reducing the signal and feeding loss.

In some embodiments, one end portions of the transmission lines 114, 124, 134 and 144 may be connected to the radiators 112, 122, 132 and 142, and the other end portions of the transmission lines 114, 124 134, and 144 may be connected to the circuit board 200.

The circuit board 200 may include, e.g., a flexible printed circuit board (FPCB). For example, a conductive bonding structure such as an anisotropic conductive film (ACF) may be bonded onto the other end portions of the transmission lines 114, 124, 134 and 144, and then the circuit board 200 may be heat-compressed.

The circuit board 200 may include a circuit wiring 205 bonded to the other end portions of the transmission lines 114, 124, 134 and 144. The circuit wiring 205 may serve as an antenna feeding wiring. For example, one end portion of the circuit wiring 205 may be exposed to an outside, and the exposed one end portion of the circuit wiring 205 may be bonded to the transmission lines 114, 124, 134 and 144. Thus, the circuit wiring 205 and the antenna structure 100 may be electrically connected to each other.

An antenna driving IC chip may be mounted on the circuit board 200. In one embodiment, an intermediate circuit board such as a rigid printed circuit board may be disposed between the circuit board 200 and the antenna driving IC chip. In one embodiment, the antenna driving IC chip may be directly mounted on the circuit board 200.

A motion sensor driving circuit or a radar processor may be mounted on the circuit board 200. For example, the antenna structure 100 and the circuit board 200 may be electrically connected, so that signal transmission/reception information of the antenna structure 100 may be transferred to the motion sensor driving circuit or the radar processor. Accordingly, a motion recognition sensor or a radar sensor including the antenna structure 100 may be provided.

Referring to FIG. 8, the display device 300 may include a display panel 310 and the above-described antenna structure 100 disposed on the display panel 310.

In example embodiments, the image display device may further include an optical layer 320 on the display panel 310. For example, the optical layer 320 may be a polarization layer including a polarizer or a polarizing plate.

In an embodiment, a cover window may be disposed on the antenna structure 100. The cover window may include, e.g., glass (e.g., ultra-thin glass (UTG)) or a transparent resin film. Accordingly, an external impact applied to the antenna structure 100 may be reduced or absorbed.

For example, the antenna structure 100 may be disposed between the optical layer 320 and the cover window. In this case, the dielectric layer 105 and the optical layer 320 disposed under the radiators 112, 122, 132 and 142 may commonly function as a dielectric layer of the radiators 112, 122, 132 and 142. Accordingly, an appropriate permittivity may be achieved so that the motion sensing performance of the antenna structure 100 may be sufficiently implemented.

For example, the optical layer 320 and the antenna structure 100 may be laminated through a first adhesive layer, and the antenna structure 100 and the cover window may be laminated through a second adhesive layer.

The circuit board 200 may be bent along, e.g., a lateral side curved profile of the display panel 310 to be disposed at a rear portion of the display device 300 and extend toward an intermediate circuit board 210 (e.g., a main board) on which the driving IC chip is mounted. The intermediate circuit board 200 may be a rigid circuit board.

The circuit board 200 and the intermediate circuit board 210 may be bonded or connected to each other through a connector, so that feeding and antenna driving control to the antenna structure 100 by the antenna driving IC chip may be implemented.

In some embodiments, the motion sensor driving circuit 220 may be mounted on the intermediate circuit board 210. In an embodiment, the motion sensor driving circuit 220 may include a proximity sensor, a gesture sensor, an acceleration sensor, a gyroscope sensor, a position sensor, a geomagnetic sensor, etc.

In some embodiments, the first radiator 112, the second radiator 122, the third radiator 132 and the fourth radiator 142 may be coupled to the motion sensor driving circuit 220. For example, the signal transmission/reception information of the antenna structure 100 may be transferred to the motion sensor driving circuit 220 through the circuit board 200 and the intermediate circuit board 210. Accordingly, a motion recognition sensor including the antenna structure 100 may be provided.

For example, the motion of the sensing target in the first direction may be sensed by the second radiator 122 and the first radiator 112. The motion of the sensing target in the second direction may be sensed by the second radiator 122 and the third radiator 132.

In an embodiment, the motion sensor driving circuit 220 may include a motion detection circuit. Signal information transmitted from the antenna structure 100 may be converted/calculated into location information or distance information through the motion detection circuit.

In an embodiment, the antenna structure 100 may be electrically connected to a radar sensor circuit, and thus signal transmission/reception information may be transmitted to a radar processor. For example, the radiators 112, 122, 132 and 142 may be electrically connected to the radar processor through the circuit board 200 and the intermediate circuit board 210. Accordingly, a radar sensor including the antenna structure 100 may be provided.

The radar sensor may analyze the transmission/reception signal to detect information on the sensing target. For example, the antenna structure 100 may transmit a transmission signal and receive the signal reflected by the sensing target to measure the distance to the sensing target.

For example, the distance of the sensing target may be calculated by measuring a time required for the signal transmitted from the antenna structure 100 to be reflected by the sensing target and received again by the antenna structure 100.

What is claimed is:

1. An antenna structure comprising:
a first radiator;
a second radiator;
a third radiator; and
a fourth radiator,
wherein the first radiator and the second radiator are arranged along a first direction, and the second radiator and the third radiator are arranged along a second direction perpendicular to the first direction, and
the first radiator, the second radiator and the third radiator are circularly polarized radiators in the same rotational direction, and the fourth radiator is a circularly polarized radiator in a rotational direction opposite to that of the first radiator, the second radiator and the third radiator.

2. The antenna structure according to claim 1, further comprising:
a first transmission line connected to the first radiator at the same layer as that of the first radiator;
a second transmission line connected to the second radiator at the same layer as that of the second radiator;
a third transmission line connected to the third radiator at the same layer as that of the third radiator; and
a fourth transmission line connected to the fourth radiator at the same layer as that of the fourth radiator.

3. The antenna structure according to claim 2, wherein each of the first radiator, the second radiator, the third radiator and the fourth radiator has an asymmetrical shape with respect to each feeding axis.

4. The antenna structure according to claim 3, wherein the first transmission line extends in a straight line along a feeding axis of the first radiator, the second transmission line extends in a straight line along a feeding axis of the second radiator, and the third transmission line extends in a straight line along a feeding axis of the third radiator.

5. The antenna structure according to claim 4, wherein an extension direction of the first transmission line and an extension direction of the second transmission line are parallel to each other, and
the extension direction of the second transmission line and an extension direction of the third transmission line are perpendicular to each other.

6. The antenna structure according to claim 3, wherein the second radiator and the third radiator have the same shape as that of the first radiator based on each feeding direction, and
the fourth radiator has a reversed shape of the first radiator.

7. The antenna structure according to claim 3, wherein each of the first radiator, the second radiator, the third radiator and the fourth radiator independently has a polygonal shape in which at least one vertex portion is truncated.

8. The antenna structure according to claim 7, wherein each of the first radiator, the second radiator, the third radiator and the fourth radiator independently has a shape in which two vertex portions facing each other among four vertex portions in a quadrangle are truncated.

9. The antenna structure according to claim 8, wherein the first radiator, the second radiator and the third radiator have a shape in which two vertex portions corresponding to the same positions based on each feeding direction are truncated, and
the two truncated vertex portions of the fourth radiator and the two truncated vertex portions of the first radiator correspond to different positions based on each feeding direction.

10. The antenna structure according to claim 2, wherein the first radiator, the second radiator, the third radiator and the fourth radiator are disposed at the same layer.

11. The antenna structure according to claim 1, further comprising a dielectric layer on which the first radiator, the second radiator, the third radiator and the fourth radiator are disposed,
wherein the first direction is parallel to a width direction of the dielectric layer, and the second direction is perpendicular to the width direction of the dielectric layer.

12. The antenna structure according to claim 1, further comprising a dielectric layer on which the first radiator, the second radiator, the third radiator and the fourth radiator are disposed,
wherein the first direction is inclined by a first tilt angle with respect to a width direction of the dielectric layer, and the second direction is inclined by a second tilt angle with respect to the width direction of the dielectric layer.

13. The antenna structure according to claim 12, wherein the first tilt angle and the second tilt angle are each in a range from 30° to 60°.

14. The antenna structure according to claim 1, wherein the first radiator, the second radiator and the third radiator serve as reception radiators, and the fourth radiator serves as a transmission radiator.

15. A motion recognition sensor comprising the antenna structure according to claim 1.

16. A radar sensor comprising the antenna structure according to claim 1.

17. An image display device comprising:
a display panel; and
the antenna structure according to claim 1 disposed on the display panel.

18. The image display device according to claim 17, wherein the first direction is parallel to a width direction of the display panel, and the second direction is perpendicular to the width direction of the display panel, and
the second radiator is the closest to a corner portion of the display panel among the first radiator, the second radiator and the third radiator.

19. The image display device according to claim 17, further comprising:
a motion sensor driving circuit coupled to the antenna structure; and
a flexible printed circuit board electrically connecting the antenna structure and the motion sensor driving circuit.
